(19) United States
(12) Patent Application Publication
(10) Pub. No.: US 2016/0277055 A1
(43) Pub. Date: Sep. 22, 2016

(54) PROTECTIVE COVER FOR A MOBILE DEVICE

(71) Applicant: Patricia ZECHNER, Zürich (CH)

(72) Inventor: Patricia ZECHNER, Zürich (CH)

(21) Appl. No.: 15/036,647

(22) PCT Filed: Nov. 14, 2014
(86) PCT No.: PCT/EP2014/074645

§ 371 Date: May 13, 2016

(30) Foreign Application Priority Data
Nov. 15, 2013 (CH) 01913/13

(51) Int. Cl. H04B 1/3888

(52) U.S. Cl. CPC H04B 1/3888

(57) ABSTRACT

The invention relates to a protective cover for a mobile device, in particular for a mobile phone or tablet computer, said protective cover comprising: a protective element (14, 15), the protective element (14, 15) being substantially flat and having an outline extending over an outline of the mobile device, and having a non-rigid peripheral area; and elastic holding elements (2), in particular elastic holding elements made of a rubber material, each holding element (2) being substantially linear in form, the holding elements (2) being arranged on a contact side of the protective element (14, 15) in such a manner that, when a mobile device is introduced into the protective cover, the holding elements extend diagonally across the corner regions of the mobile device, thereby securing the mobile device to the contact side by a rear side of the mobile device.

### TECHNICAL FIELD

The present invention is in the field of protective devices, in particular protective covers for mobile devices such as mobile phones and tablet PCs.

### BACKGROUND, PRIOR ART

Mobile devices such as mobile phones, for example, smartphones or tablet computers, are everyday objects that are practically constantly carried along and used by many people. Accordingly there is a need to protect these relatively expensive devices using corresponding bags or covers, wherein the easy accessibility and usability of all possible functions of the devices should be guaranteed. Moreover, there is a significant increase in fashionable and aesthetic requirements, which in turn have repercussions on the functional and technical aspects such as the selection of suitable materials, the manner of attachment of the mobile device, etc.

### PRESENTATION OF THE INVENTION

It is a general task of the present invention to provide a cover or protective cover, which largely or completely meets the requirements imposed on a protective cover for mobile devices. This protective case should partially or completely avoid problems of known covers. The task is achieved in general form by the subject matter of the independent patent claims. Other exemplary as well as particularly advantageous embodiments emerge from the dependent patent claims as well as the total disclosure of this document.

A protective case for a mobile device according to the invention, in particular for a mobile phone or a tablet computer, comprises: a protective element, wherein the protective element features a substantially flat shape, and wherein the protective element features an outline, which projects beyond an outline of the mobile device. The protective element features a flexible rim. The protective cover further comprises elastic retaining elements, in particular elastic retaining elements made of a rubber material, whereby each of the elastic retaining elements have a substantially linear shape. The retaining elements are arranged on a contact side of the protective element in such a manner that they, with a mobile device inserted in the protective cover, diagonally span corner areas of the mobile device and thus fix the mobile device with a back side of the mobile device on the contact side. Furthermore, the holding elements are matched to the mobile device in such a manner that the mobile device and particularly its user interface, such as displays and/or touch screen, are accessible in the inserted state and preferably fully usable.

Instead of a mobile phone, in particular a smartphone or a tablet computer, the cover can also be designed to accommodate other mobile devices, such as an mp3 player, a dictation machine etc.. The mobile device is preferably hand-held and is also referred to as a “mobile device”.

Due to the fact that the outline of the protective element projects beyond the outline of the mobile device and due to the fixing of the mobile device in the corner areas, a protective cover according to the invention can be advantageously used for mobile devices, for example, mobile phones, of different sizes and with varying outline, without having to take the mobile device out of the protective cover for use or operation.

Depending on embodiment, the flexible rim is not necessarily confined to an edge area, but can also, for example, extend over a third or half of the outline surface. The flexible rim can in particular form a part of the contact surface, on which the back side of the mobile device inserted into the protective cover rests. Moreover, the entire protective element can be soft or flexible.

The protective cover and in particular its protective element is also called a “cover”.

The terms “inside” and “outside” are used in this document with respect to the insertion and when appropriate, to the closed cover. In case of inserted mobile device, inner surfaces face the mobile device and are, for example, in contact with this, while outer surfaces face away from the mobile device.

The retaining elements are also designated in their entirety as the “holder”. It can consist of elastic bands, cords or threads, for example, rubber band, elastic tape or the like.

Flexible is also referred to as “soft” and a flexible material accordingly as “soft material”. In addition to a rim, the entire protective element can be in particular flexible or soft. The terms “soft” or “flexible” are to be understood here in such a manner that a deformation is possible with a small force, in particular with a force easily applied by a person. Without the action of such external force, that is, essentially only under the influence of gravity, there can optionally be a certain degree of dimensional stability.

“Flexible” or “soft” in this context also means in particular that the flexible material or soft material can be bent, folded and/or rolled by hand without great force and without technical tools, such as in particular a hinge, without being destroyed in its structure and/or optics.

In one embodiment, the protective cover comprises four retaining elements, wherein the four retaining elements are arranged with rectangular outline to obliquely span the four corner areas of a mobile device.

The mobile device typically has a form with relatively large base area or a relatively large outline as compared to its thickness or height, as is the case for typical mobile phones, smartphones and tablet PCs. Preferably three of the four retaining elements are sufficient for secure fixing of the mobile device.

In one embodiment, the protective element comprises a front part and a rear part, wherein the front part and the rear part can be moved in relation to each other, in particular by flipping, folding and/or rolling. In a closed configuration of the protective cover, the front part and the rear part are superimposed and enclose, with the mobile device inserted, the mobile device like a sandwich between them. The contact surface is thereby formed by the inside of the rear part. The movement can take place in particular along a line. The flexible edge zone can then form a part of the rear part or the entire rear part. Furthermore, the front part may be completely or partially flexible.

In such an embodiment with front part and rear part, the outline advantageously projects beyond at least the rear part, and typically the outline of the front part and the rear part respectively projects beyond the outline of the mobile device.

The shape and in particular the outline of the protective cover is preferably adapted to the outline of the mobile device. Typically, the protective cover has in general a rectangular outline in the closed as well as open configuration. The movement, in particular the flipping, folding and/or rolling can be carried out along a long side or narrow side.

In one embodiment, the front part is movable relative to the rear part from the closed configuration by an angle that, at least approximately, is 360 degrees, so that the front part and the rear part lie at least substantially flat above one another. This relative position is also referred to as “back to back” position.

In one embodiment, the protective cover comprises a locking device, in particular a locking device with a button, a snap fastener, a hook, a lace, an elastic band, a hook-and-loop closure tape, a zipper and/or a magnet for closing the protective cover.

In one embodiment, the protective element features two layers one above the other in the form of an outer layer and an inner layer, wherein at least one of the outer layer and the inner layer consists of a flexible soft material, in particular tissue, fabric, knitted fabric, or leather. In this case, in particular a rim zone of the layer is flexible.

In one embodiment, the protective element comprises a dimensionally stable middle layer that is arranged between the outer layer and the inner layer, in particular inserted, incorporated, glued, stitched or ironed. The dimensionally stable middle layer is used for obtaining dimensional stability or for gaining strength. If the stability and rigidity of the dimensionally stable middle layer is so great that a simple deformability by hand, as described above, is not given, then the dimensionally stable middle layer does not extend preferably over the entire surface of the outer and inner layer, rather spares at least the flexible rim or also a larger area. If, however, the dimensionally stable layer is still sufficiently flexible in order to enable easy deformability by hand, it can extend entirely or substantially over the total area. The optional dimensionally stable middle layer can consist of for example, fusible interlining, plastic, cardboard, metal, or a combination of these and/or similar materials.

In one embodiment, the protective element comprises a flexible middle layer, wherein the flexible middle layer in particular consists of fleece, cotton, or foam, wherein the flexible middle layer is arranged between the outer layer and the inner layer, in particular is inserted, incorporated, glued, stitched or ironed. The optional flexible middle layer is used especially for the padding, but can be also used for the dimensional stability, depending on material and dimensioning.

In one embodiment, the flexible rim is assigned to a retaining element and a corner area of the mobile device. The flexible rim can be moved away, in particular flipped away, folded away and/or rolled away, with the mobile device inserted, after detaching the span by the associated retaining element of the associated corner region or by stretching the associated retaining element while maintaining the spanning, so that a part of the back side of the mobile device is accessible in the displaced state of the flexible rim, in particular visually accessible.

Such an embodiment allows a mobile device, i.e. a smartphone, to use an existing camera in the mobile device, without having to remove the mobile device from the protective cover for this purpose and without necessitating any holes, cutouts or the like in the protective cover in order to ensure the optical accessibility of the lens. In relation to the outline, the lens is typically located near a corner of the mobile device. Therefore only one of the for example, four retaining elements, namely that retaining element which spans the corner with the lens, is detached for use. If the camera is not used, the protective cover ensures mechanical protection of the lens. In this case, the rim is dimensioned sufficiently large in order to reach from the edge of the protective element over the lens. The flexible rim has, for example, a triangular outline and constitutes a corner area of the protective element. After detaching the associated retaining element, it can be, for example, diagonally pivoted or folded backward, thus exposing the lens. Depending on the specific location of the lens on the rear side of the mobile device, it is also possible to move away the corner area without detaching the retaining element, wherein the retaining element is accordingly elongated.

Furthermore, the option can be provided to alternatively detach various retaining elements and thus to move away various rims, for example, a left or alternatively a right corner area. Furthermore, the option can be provided to detach more than one retaining element, for example, two adjacent retaining elements, then, to move away a larger area of the protection element, for example, parallel to one of its edges. In order to ensure the fixing and hold of the mobile device, an elastic transverse band can be provided, which spans the mobile device when needed, for example spans transversely and thus fixed.

In one embodiment, the protective element comprises one or more accessory retaining element(s) on an outer side and/or inner side, in particular one or more elastic tab(s) or strap(s) for accommodating an accessory element.

The accessory retaining element(s) can in particular be designed for accommodating a cylindrical accessory element in an orientation parallel to one edge of the inserted mobile device. In this manner, the accessory element can also be used as a standing element for a slanted or lectern-like position of the protective cover with inserted mobile device. The accessory retaining element(s) thus fulfill(s) a dual function, by enabling on the one hand a compact housing of the accessory element and on the other hand, by way of the accessory element, enabling the device to be set up in a slanted or lectern-like position on a horizontal surface such as a table. The accessory element can be, for example, a lipstick or lip salve, which in this way is also housed as compact and handy.

Other aspects and optional embodiments are as follows:

A cover (1) for a mobile device, for example, a mobile phone, tablet, MP3 player and the like is disclosed, characterized in that the holder for the mobile device is made of elastic bands or threads, for example, rubber bands, stretch bands or the like and the object is fixed by means of these. The object can be in particular the mobile device.

In one embodiment, the cover is characterized in that the cover consists of two superposed layers, an outer layer and an inner layer.

In one embodiment, the cover is characterized in that the outer layer consists of tissue, fabric, knitted fabric, leather or other soft material.

In one embodiment, the cover is characterized in that the inner layer consists of tissue, fabric, knitted fabric, leather or other soft material.

In one embodiment, the cover is characterized in that another middle layer is inserted, incorporated, glued, ironed or similarly included for dimensional stabilization or for obtaining strength.

In one embodiment, the cover is characterized in that a further middle layer consisting of soft filling material, for example, fleece, cotton, foam or the like is inserted, incorporated, glued, ironed or included similarly.

In one embodiment, the cover is characterized in that the elastic bands or threads are arranged diagonally over the corners of the mobile device to be fixed.

In one embodiment, the cover is characterized in that the holder is placed diagonally over the corners and glued, sewn and/or fixed in another way at the ends.

In one embodiment, the cover is characterized in that one or more compartments for credit cards or the like are incorporated on the inside or outside of the cover.

In one embodiment, the cover is characterized in that one or more tabs are incorporated, for example, for key chains, a snap hook or for fastening an object such as lipstick on the outside or inside of the cover. A snap hook can be used in particular for fixing the protective cover with inserted mobile device to a piece of garment, for example, a belt loop of trousers.

In one embodiment, the cover is characterized in that one or more compartments are incorporated on the outside or inside, which can be closed with a button, snap fastener, hook, hook-and-loop closure, zipper or the like.

In one embodiment, the cover is characterized in that the front side of the closed cover can be opened and folded by 360 degrees, so that it lies back to back with the back side of the cover.

In one embodiment, the cover is characterized in that the ends of the holder are fixed or covered by a ribbon or the like.

In one embodiment, the cover is characterized in that the edges of the cover are enclosed with a tape, a serging seam, decorative stitching or the like.

In one embodiment, the cover is characterized in that the outermost layer with the innermost layer is turned over at the edges.

In one embodiment, the cover is characterized in that the contact surface of the cover is larger than the mobile device and the surface of the holder is thus surrounded. The outline of the contact surface in this case represents the outline.

In one embodiment, the cover is characterized in that the front side of the closed cover and the back side of the closed cover are closed by using a button, snap fastener, hook, lace, elastic tape, hook-and-loop closure, zipper, a magnet or the like.

### EXEMPLARY EMBODIMENTS

Exemplary embodiments of a cover or protective cover according to the invention will be elaborated in the following with additional reference to the figures.

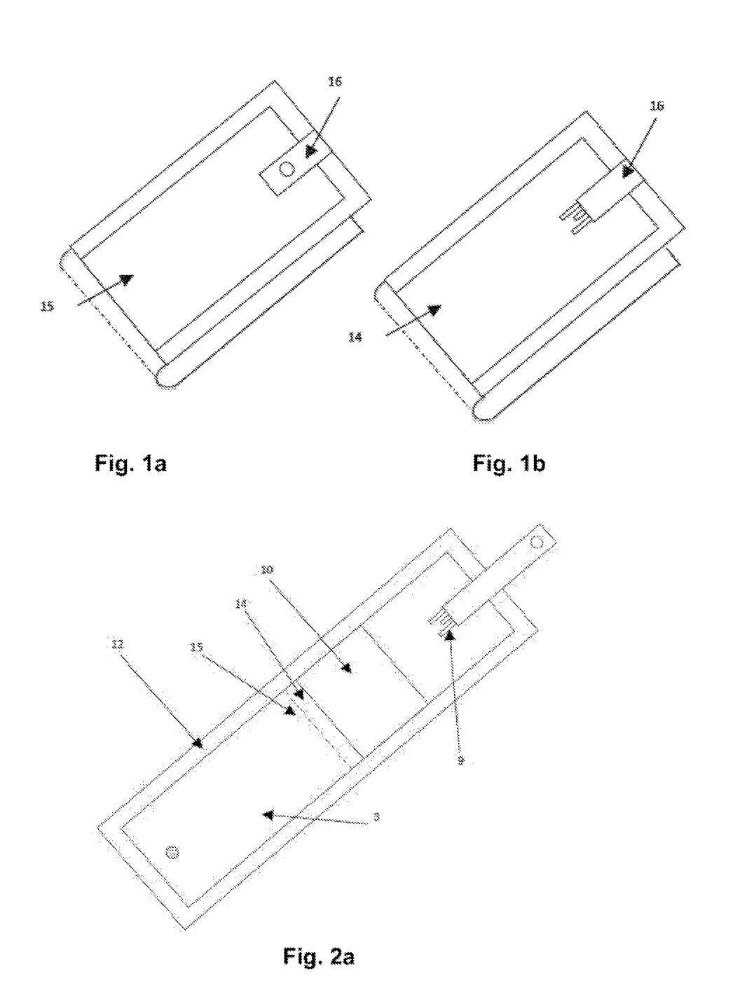

FIG. 1a, 1b schematically show a protective cover or cover according to one embodiment in a front view and a rear view in a closed configuration;

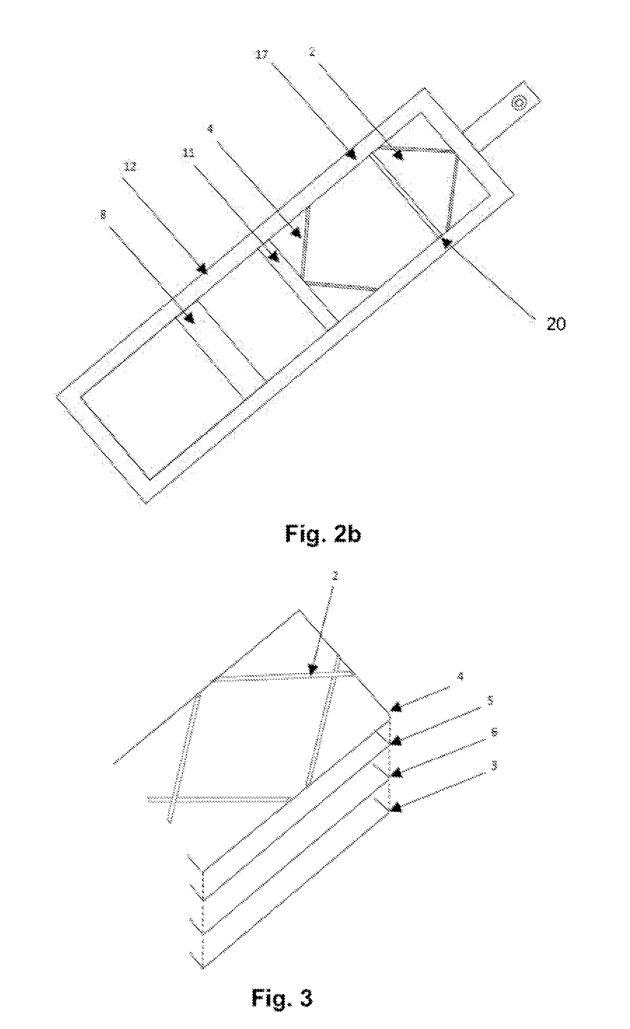

FIG. 2a, 2b schematically show a protective cover or cover according to the same embodiment in a front view and a rear view in an open configuration;

FIG. 3 schematically shows an exemplary internal structure of a protective element of the same embodiment;

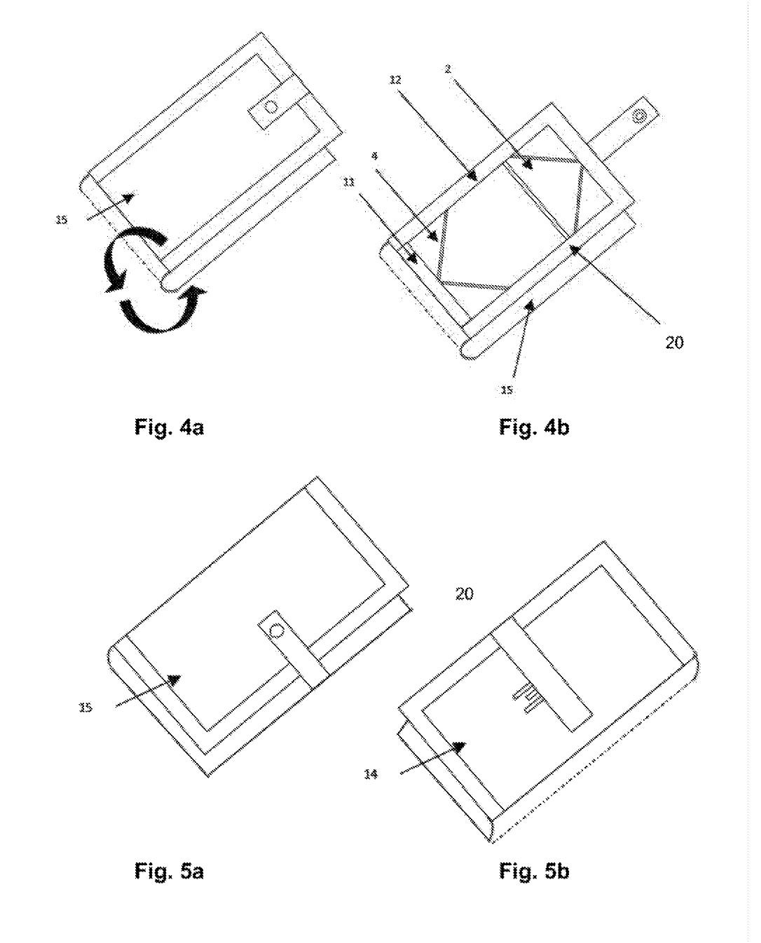

FIG. 4a, 4b schematically show the change between the open and closed configuration of the same embodiment;

FIG. 5a, 5b schematically show a protective cover or cover according to another embodiment in a front view and a rear view in a closed configuration;

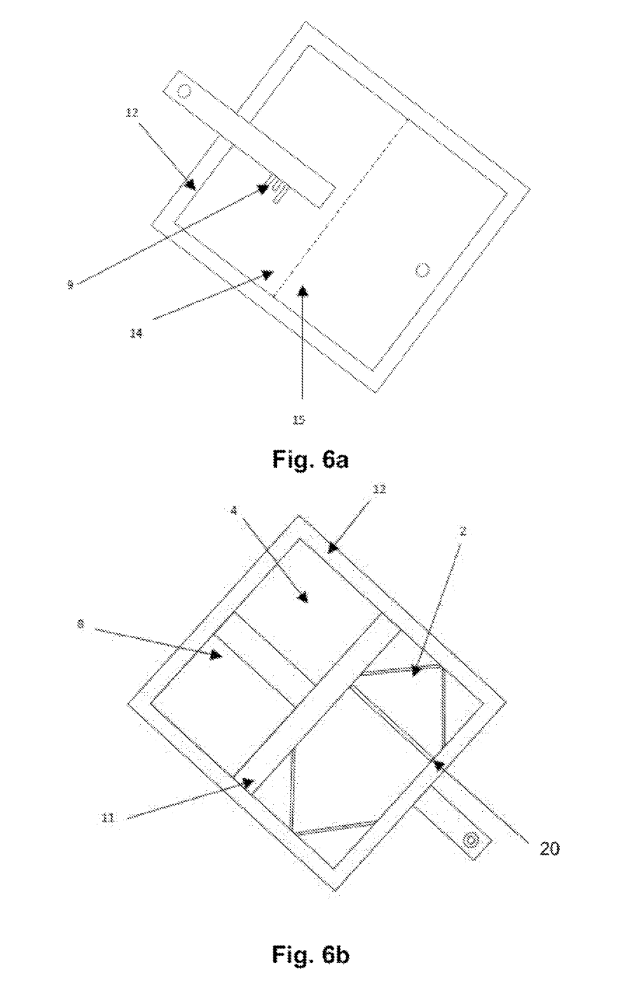

FIG. 6a, 6b schematically show a protective cover or cover according to the other embodiment in a front view and a rear view in an open configuration;

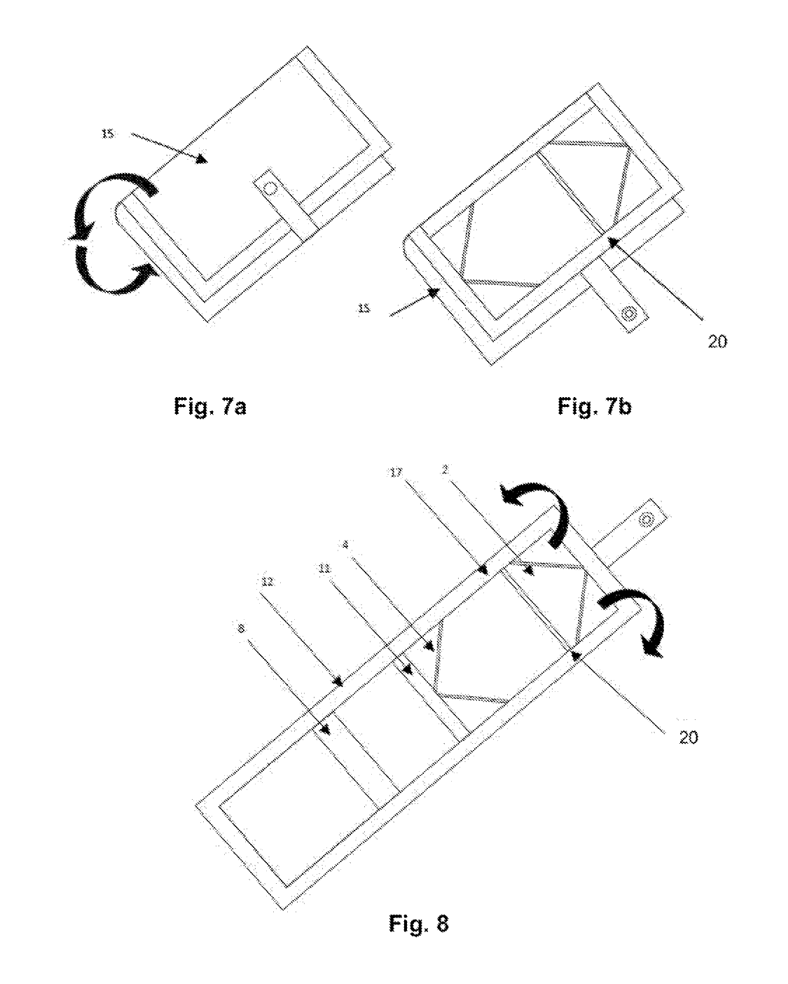

FIG. 7a, 7b schematically show the change between the open and closed configuration of the other embodiment;

FIG. 8 schematically shows an application of a protective cover in accordance with the embodiment in accordance with FIG. 1a and the following;

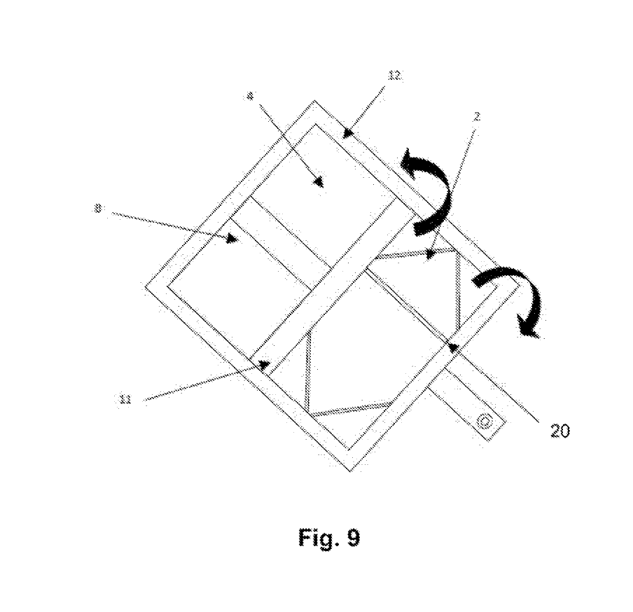

FIG. 9 schematically shows an application of a protective cover in accordance with the other embodiment in accordance with FIG. 5a and the following.

FIGS. 1a, 1b schematically show a protective cover or cover according to one embodiment in a front view and a rear view in a closed configuration or closed state. The protective cover comprises a front part 15 and a rear part 14, which essentially have identical size and in particular essentially an identical outline. In the illustrated closed state, they are superposed and are essentially congruent. The opening or closing of the protective cover and thus the change between the open and closed configuration takes place here along a narrow side (shorter side). The locking device shown also comprises an optional locking device 16 in the form of a for example, firmly sewn belt with a push button.

FIG. 2a illustrates the protective cover of FIG. 1, 1b in a flipped open configuration in an external view, in which, as opposed to the closed configuration, the rear part 14 has been flipped flat by 180 degrees.

The flat protective element of the protective cover is surrounded by a circumferential belt 12, wherein additionally or alternatively a decorative stitch and/or a serging seam can be present. In this view, the outer layer 3 of the protective element is visible, which for example, consists of fine leather, fabric, knitted material or other textile material.

Furthermore, for example, one or more compartments 10 are incorporated in the rear part 14, for holding essentially flat objects such as entry tickets, credit cards, banknotes, coins, etc. For example, in the area of the locking device 16, tabs or loops 9 are further arranged for accommodating or attaching other objects or accessory elements and/or utensils such as lipstick Likewise, for example, a snap hook can be present additionally or alternatively. The tabs or straps 9 can in particular accommodate a corresponding cylindrical object such as lipstick in such a manner that it is aligned parallel to one edge of the protective cover and thus can be used for obliquely positioning the mobile device received in the protective cover.

FIG. 2b corresponds to FIG. 2a with the difference that FIG. 2b shows the interior view corresponding to FIG. 2a.

The retaining elements for the mobile device are formed by elastic threads, cords or belts 2, which span the corner areas of the front part diagonally and thus feature a rhombic shape in plain view together. In alternative embodiments, they can also jointly feature a further, for example, hexagonal or octagonal shape in the mobile device. The elastic threads, bands or cords 2 are to be connected to the protective element, for example, by gluing and/or stitching. The total contact area or the outline of the protective element or the protective cover is thereby larger than that of the mobile device, so that there is an all-round projection. The projection can wholly or partially consist of the band 12.

In the illustration of FIG. 2b, the inner layer 4 of the protective element is visible, the top side of which forms the contact surface on which the inserted mobile device lies.

The ends of the retaining elements 2 are fixed and covered by an optional ribbon 11.

Furthermore, in the inner side of the front part, optionally one or more compartments 8 are incorporated, which are designed along with the optional compartments 10 for essentially accommodating flat objects, such as entry tickets, credit cards, bank notes etc.

Furthermore, an optional elastic transverse band 20 is provided on the inner layer 4 (the contact surface), which transversely spans the contact surface and its function is explained further below.

FIG. 3 shows schematically and by way of example a possible structure of the protective cover or in particular of the protective element of the protective cover as a sandwich in the essentially congruent layers.

An outer layer 3 and an inner layer 4 are made of a flexible material or soft material, as previously shown. Between the outer layer 3 and the inner layer 4, a (first) middle layer 5, and a (second) middle layer 6 are arranged. The (first) middle layer 6 consists of fusible interfacing or for example, a plastic foil, and ensures a certain dimensional stability of the protective cover. The (second) middle layer is soft or flexible and consists of fleece, cotton, foam, or the like. It is preferably flexible or yielding in the direction of thickness and is used primarily as cushioning. In the embodiment shown, the (first) middle layer extends over the entire area. It is dimensioned in its rigidity in such a manner that easy deformation by hand, as described above and in following, is ensured.

FIG. 4a and FIG. 4b illustrate the change between the open and the closed configuration of the protective cover by folding the front part 15 by 360 degrees, so that in the open or folded open configuration (FIG. 4b), the front part 15 and the rear part 14 lie “back to back” and on one another.

The advantageous use in connection with a camera of the mobile device is further apparent from the FIGS. 2b and 4b. It is assumed that the camera lens is located in the area of a corner of the mobile device, for example, the upper left corner in FIG. 4b. In order to expose the lens for use, thus making it visually accessible, only the assigned retaining element 2 (in this example, the upper left retaining element) must be detached and the span of the corresponding corner of the mobile device must be raised. Then the corresponding corner area of the rear part 14 is easily folded down by hand and thus exposes the lens without being removed from the protective cover (also see FIG. 8). Provided that the (first) middle layer 5 according to FIG. 3 has an excessively high stiffness for this in alternative embodiments, the corresponding corner area can be cut out from the (first) middle layer 5. As shown above, it is also possible, depending on the arrangement of the lens, to arrive at the lens using elastic elongation and without detaching the associated retaining element.

FIGS. 5a, 5b, 5a, 5b as well as 7a, 7b show views of another embodiment corresponding to FIGS 1a, 1b, 2a, 2b, as well as 4a, 4b, in which the opening and closing takes place over the long side (longer side) of the protective element.

The moving away of a corner part of the rear part depicted above is especially suitable in connection with mobile devices, in which an optical lens is located in a corner. In other mobile devices, for example, some tablet computers, as well as some mobile phones, a lens is in contrast located centrally based on one lateral edge, for example, the short lateral edge for rectangular outline. Here, the lens cannot be exposed by diagonal turning of a corner for use. For this case, the additional elastic band 20 can be provided, whose function will be elaborated with reference to FIG. 8 in the following.

The transverse band 20 can basically consist of the same material as the retaining elements 2 and in particular have similar mechanical properties, however, is preferably wider. In case of the inserted mobile device, the transverse band 20 is normally located (if the camera of the mobile device is not used) between the back side of the mobile device and the contact area. To expose the lens to be used, the span of two adjacent corners (in the example of FIG. 8 on the narrow side top right) is detached. Subsequently, the transverse band 20 is temporarily pulled over the mobile device, so that it transversely spans the mobile device. After detaching the span of two adjacent corners, a larger partial area of the rear part can be moved away, for example, folded away or rolled away. The two remaining retaining elements 2 (in the example of FIG. 8 on the narrow side of the bottom left) ensure a hold or fixation in the protective cover for the period of use of the camera or the lens together with the transverse band 20. If the lens is no longer needed, the fixing of the mobile device by the transverse band can be canceled and carried out exclusively by means of the retaining elements 2.

FIG. 9 shows a view corresponding to FIG. 8 for the other embodiment of the protective cover.

1. Protective cover for a mobile device, in particular for a mobile phone or a tablet computer, the protective cover comprising:
a protective element (14, 15), wherein the protective element (14, 15) comprises a substantially flat form, and wherein the protective element comprises an outline which projects beyond an outline of the mobile device, and wherein the protective element comprises a flexible rim;
elastic retaining elements (2), in particular elastic support elements consisting of a rubber material, wherein the elastic retaining elements (2) each have essentially linear form, and wherein the retaining elements (2) are arranged on a contact side of the protective element (14, 15) in such a manner that in case of the mobile device inserted into the protective cover the corner areas of the mobile device span diagonally and thus fix the mobile device with a back side of the mobile device on the contact side.

2. Protective cover according to claim 1, wherein the protective cover comprises four retaining elements (2), wherein the four retaining elements (2) are arranged with rectangular outline to diagonally span the four corner areas of a mobile device.

3. Protective cover according to claim 1, wherein the protective element (14, 15) comprises a front part (15) and a rear part (14), wherein the front part (15) and the rear part (14) can be moved to each other, in particular by flipping, folding and/or rolling, and in a closed configuration of the protective covering the front part (15) and the rear part (14) are superimposed and enclose the mobile device sandwiched between them when the mobile device is inserted.

4. Protective cover according to claim 3, characterized in that the front part (15) can be moved relative to the rear part (14) from the closed configuration by an angle that, at least approximately, is 360 degrees, so that the front part (15) and the rear part (14) lie at least substantially flat above one another.

5. Protective cover according to claim 3, characterized in that the protective cover comprises a locking device (16), in particular a locking device with a button, a snap fastener, a hook, a lace, an elastic band, a hook-and-loop closure tape, a zipper and/or a magnet for closing the protective cover.

6. Protective cover according to claim 1, characterized in that the protective element (14, 15) comprises two layers one above the other in the form of an outer layer (3) and an inner layer (4), wherein at least one of the outer layer (3) and the inner layer (4) at least in a rim consists of a flexible soft material, in particular tissue, fabric, knitted fabric, or leather.

7. Protective cover according to claim 6, characterized in that the protective element (14, 15) comprises a dimensionally stable middle layer (5) which is arranged between the outer layer (3) and the inner layer (4), in particular is inserted, incorporated, glued or ironed.

8. Protective cover according to claim 6, characterized in that the protective element (14, 15) comprises a flexible middle layer (6), wherein the flexible middle layer (6) in particular consists of fleece, cotton, or foam, wherein the flexible middle layer is arranged between the outer layer (3) and the inner layer (4), in particular is inserted, incorporated, glued or ironed.

9. Protective cover according to claim 1, characterized in that a retaining element (2) as well as a corner area of the mobile device are assigned to the flexible rim, and the flexible rim can be moved away in case of the inserted mobile device after detaching the span of the associated corner region by the associated retaining element or by stretching the associated retaining element while maintaining the span, in particular can be flipped away, folded away and/or rolled away, so that a part of the back side of the mobile device is accessible in the moved away state of the flexible rim, especially visually accessible.

10. Protective cover according to claim 1, characterized in that the protective element comprises one or more accessory retaining element(s) (9) on an outer side and/or inner side, in particular one or more elastic tab(s) or strap(s) for accommodating an accessory element.
